(19) United States
(12) Patent Application Publication
(10) Pub. No.: US 2017/0001460 A1
(43) Pub. Date: Jan. 5, 2017

(54) Attachable Greeting Card

(71) Applicants: Khishigbayar TUMURBAATAR, Alexandria, VA (US); Enkhtamir ENKHDAVAA, Alexandria, VA (US)

(72) Inventors: Khishigbayar TUMURBAATAR, Alexandria, VA (US); Enkhtamir ENKHDAVAA, Alexandria, VA (US)

(21) Appl. No.: 14/788,951

(22) Filed: Jul. 1, 2015

(51) Int. Cl. B42D 15/04; G09F 1/04

(52) U.S. Cl. CPC B42D 15/045; G09F 1/04

(57) ABSTRACT

The invention is a greeting card that can be disassembled to remove a decorative cutout portion comprising an adhesive strip. The decorative cutout component can be removably attached to a surface, such as a wall, refrigerator or computer monitor, for display purposes.

### CROSS REFERENCE TO RELATED APPLICATIONS

Not applicable.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

Field of the Invention

The invention is a greeting card that can be attached to a surface.

Background of the Invention

It is well known that recipients of greeting cards often display the cards in their homes or places of work, for the enjoyment of themselves and others. Displayed cards are particularly common in office workplaces, both in private offices and common areas. However, a card on display often must be removed after only a brief period of time due to the fact that it takes up valuable surface area.

Greeting cards currently available in the market are nearly always quadrilateral in shape and comprise a single fold down the middle. Known cards tend to vary only with regard to their sizes and dimensions, i.e., square or rectangle. To be displayed for viewing in a home or office, such cards must be partially opened and placed on a horizontal surface, such as a table or mantle.

Known greeting cards may also be affixed to a vertical surface using some extraneous adhesive, such as glue or tape. Many such types of adhesive can cause permanent damage to surfaces, either by stripping surface layers upon removal, or leaving behind sticky residue. The removal of such residue often requires the use of a caustic solvent, which can itself further damage a wall or table top. In particular, such adhesives can peel paint, crack plaster or cause stains on walls.

Certain products are now available for the hanging of posters or similar items, which allow for surface adhesion while also allowing for clean removal.

The object of the invention is to provide a greeting card with an attractive, removable component that can be mounted on a surface for display without damaging or disfiguring such surface. This object is attained with a greeting card comprising the features disclosed herein.

### BRIEF SUMMARY OF THE INVENTION

In a preferred embodiment, a removably attachable greeting card comprising: a greeting card body; a decorative cutout, comprising an adhesive strip and adhesive cover layer, wherein the decorative cutout is removable from the greeting card body.

In another preferred embodiment, the removably attachable greeting card as described herein, wherein the decorative cutout is demarcated by a perforated line cut into the greeting card body.

In another preferred embodiment, the removably attachable greeting card as described herein, wherein the adhesive strip comprises a permanent adhesive side, attached to the decorative cutout, and a removable adhesive side covered by the adhesive covering layer.

In another preferred embodiment, the removably attachable greeting card as described herein, wherein the removable adhesive side of the adhesive strip comprises a pressure-sensitive adhesive.

In a preferred embodiment, a method of use of the attachable greeting card as described herein, comprising the steps of: (i) removing the decorative cutout from the greeting card body along the perforated line; (ii) removing the adhesive cover layer from the adhesive strip; and (iii) affixing the decorative cutout to a surface by pressing the adhesive strip to a surface.

In another preferred embodiment, the method of use as described herein, further comprising the step of removing the affixed decorative cutout by grasping the lower edge of the decorative cutout and slowly pulling downward until the adhesive strip releases from the surface.

### BRIEF DESCRIPTION OF THE DRAWINGS

FIG. 1 is a line drawing evidencing an exploded view of the greeting card device with a decorative cutout and adhesive strip feature.

FIG. 2 is a line drawing evidencing the display of the decorative cutout feature of FIG. 1, as mounted for display on the back of a computer monitor.

### DETAILED DESCRIPTION OF THE INVENTION

The invention is a greeting card that can be disassembled to remove a decorative cutout component, which component comprises an adhesive strip. The decorative cutout can be removed from the greeting card body and then attached via the adhesive strip to a surface, such as a wall, refrigerator or computer monitor, for display purposes.

The greeting card body may be of any useful shape or size, and contains a plaque decorative cutout component that is demarcated from the larger card by a perforation line. The decorative cutout is shaped in a design making it attractive for display as a stand-alone decoration. The perforation line allows the decorative cutout to be quickly and simply removed from the greeting card.

The greeting card may be made from a stiff paper, cardboard, poster board, or similar material. Custom created graphics, designs and text may be printed on the main card body.

Preferably, the perforation line is a clean cut line around the outside of the decorative cutout, with two or more small, uncut points of attachment to the larger greeting card that can be easily broken with the user's fingers to allow for full removal of the decorative cutout. In an alternative embodiment, the perforation line may comprise a line of closely packed small holes following the outer line of the decorative cutout. Preferably, the decorative cutout will have graphic and/or textual materials printed on both sides, thereby allowing each side to function for display purposes.

Certain products are now available for the hanging of posters, calendars or other cardboard or paper hangings, which allow for surface adhesion while also allowing for clean removal. For example, the 3M company's Command® brand of adhesive products includes single-use strips of varying sizes, sold in lots of 24 or more. These products include a non-adhesive cover layer which is peeled off immediately prior to use, thereby exposing the underlying adhesive surface.

In a preferred embodiment, the adhesive strip will be comprised of a double-sided film carrier with a permanent adhesive on the side attached to the decorative cutout and removable adhesive on the side covered by the adhesive cover layer. The adhesive cover layer has a dry surface on both sides, making removal fast and easy. A preferred width of the adhesive strip is between 0.5″ and 1.0″. A more preferred width is 0.75″.

One or more adhesive strips will be located on one or both sides of the decorative cutout, and placed to allow for certain types of display. For example, a decorative cutout with a top edge and a bottom edge may have the adhesive strip located along the bottom edge to allow for mounting on the back of a computer monitor, with one side of the decorative cutout visible to the computer user above the monitor, and the full other side of the decorative cutout visible in the other direction. In another configuration, the adhesive strip may be placed in the center of one side for wall mounting, or at the top edge of the decorative cutout for a hanging type of mounting.

Preferably, the permanent adhesive will be hot melt rubber-based. Alternative permanent adhesives may be taken from the list comprising or polychloroprene, cyanoacrylate, polyvinyl acetate, epoxies, neoprene, methacrylate, or other known permanent adhesive materials.

Preferably, the removable adhesive will be water-based acrylic. In a more preferred embodiment, the removable adhesive will be a pressure-sensitive adhesive.

In certain embodiments, a decorative cutout may contain space or graphical designs allowing the user to add personal messages and/or images, including photographs, to personalize the display.

A method of use of the greeting card invention disclosed herein above begins with a user receiving the greeting card, and removing the decorative cutout along the perforated line. The use may then remove the adhesive cover layer from the underlying adhesive strip, exposing the latter. The user may then press the adhesive strip against a wall or the surface of any object, thereby adhering the decorative cutout to the wall or other surface. In certain circumstances, only one side of the decorative cutout may be visible for display, while in other circumstances both sides of the decorative cutout may be visible.

### DETAILED DESCRIPTION OF THE FIGURES

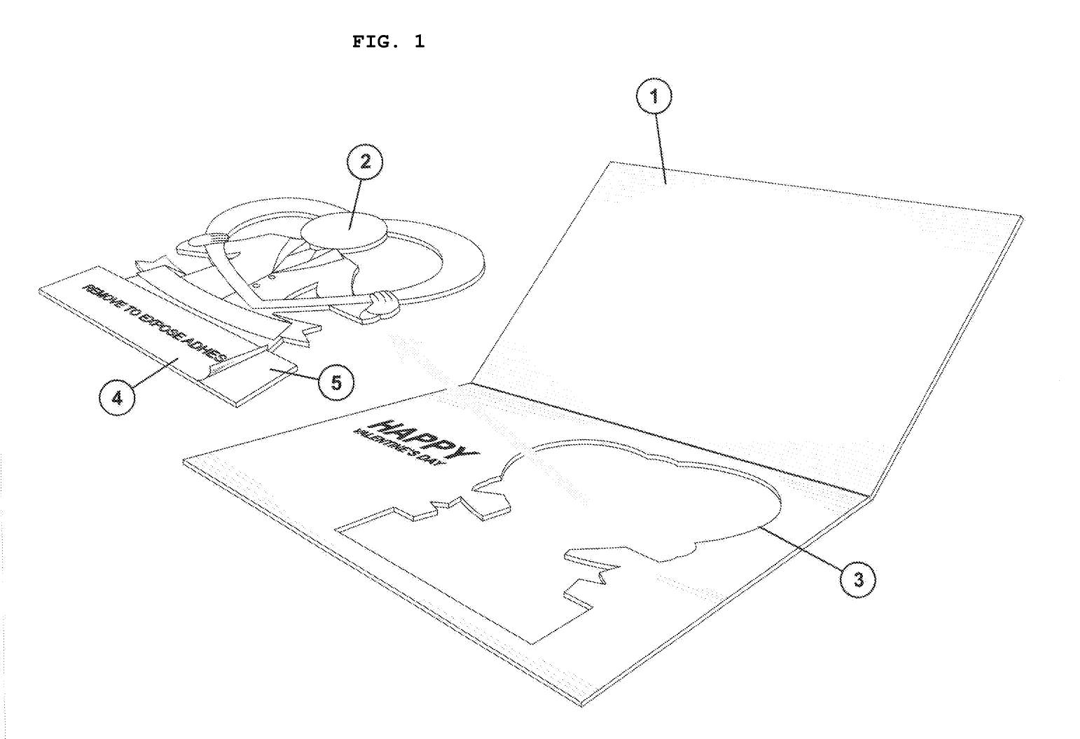

FIG. 1 is a line drawing showing an exploded view of the greeting card body 1 with a decorative cutout 2 removed therefrom along the perforated line 3. The decorative cutout 2 is shown with the adhesive strip 5 attached thereto, and adhesive cover layer 4 partially peeled back, exhibiting the outward-facing surface of adhesive strip 5.

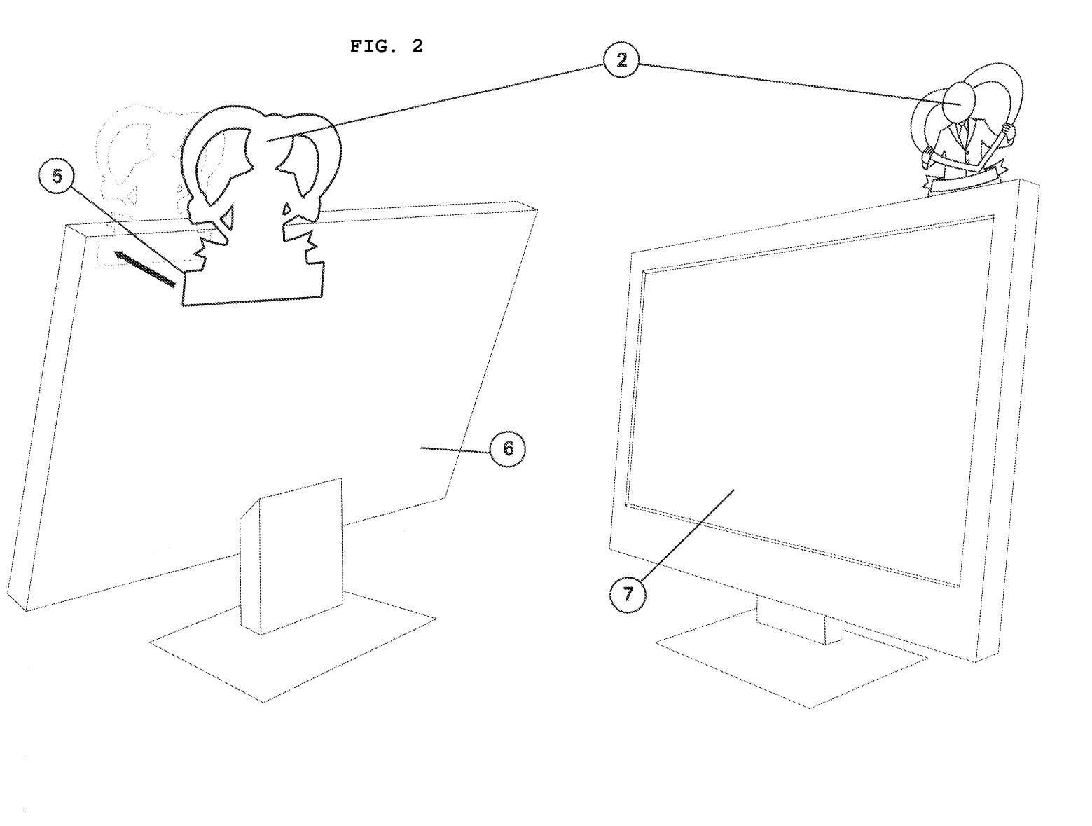

FIG. 2 is a line drawing showing decorative cutout 2 being affixed to a mounting surface 6 utilizing the adhesive strip 5 (not shown). In this figure, the decorative cutout is affixed to the rear of a computer monitor 7, such that adhesive strip 5 runs along the upper edge of the mounting surface 6, allowing one side of the decorative cutout 2 to be viewed by the computer user over the monitor 7, while the other side of the decorative cutout 2 is viewed from the opposite direction.

### LIST OF REFERENCE NUMBERS

1 Greeting card body

2 Decorative cutout

3 Perforated line

4 Adhesive cover layer

5 Adhesive strip

6 Mounting surface

7 Computer monitor

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A removably attachable greeting card comprising:
a greeting card body;
a decorative cutout, comprising an adhesive strip and adhesive cover layer, wherein the decorative cutout is removable from the greeting card body.

2. The removably attachable greeting card of claim 1, wherein the decorative cutout is demarcated by a perforated line cut into the greeting card body.

3. The removably attachable greeting card of claim 1, wherein the adhesive strip comprises a permanent adhesive side, attached to the decorative cutout, and a removable adhesive side covered by the adhesive covering layer.

4. The removably attachable greeting card of claim 3, wherein the removable adhesive side of the adhesive strip comprises a pressure-sensitive adhesive.

5. A method of use of the attachable greeting card of claim 1, comprising the steps of:
(i) removing the decorative cutout from the greeting card body along the perforated line;
(ii) removing the adhesive cover layer from the adhesive strip; and
(iii) affixing the decorative cutout to a surface by pressing the adhesive strip to a surface.

6. The method of use of claim 5, further comprising:
(iv) removing the affixed decorative cutout by grasping the lower edge of the decorative cutout and slowly pulling downward until the adhesive strip releases from the surface.
